(19) United States
(12) Patent Application Publication
(10) Pub. No.: US 2019/0031135 A1
(43) Pub. Date: Jan. 31, 2019

(54) Seat Belt Buckle With Built-in Cutter

(71) Applicants: WILSON GUTIERREZ, Naples, FL (US); OSCAR ESCOBAR, Naples, FL (US)

(72) Inventors: WILSON GUTIERREZ, Naples, FL (US); OSCAR ESCOBAR, Naples, FL (US)

(21) Appl. No.: 15/663,738

(22) Filed: Jul. 29, 2017

(51) Int. Cl. B60R 22/32; A44B 11/00; A44B 11/25; B26B 11/00

(52) U.S. Cl. CPC B60R 22/32; A44B 11/005; B60R 2022/328; B26B 11/00; A44B 11/2546

(57) ABSTRACT

A seat-belt buckle with built-in belt cutter is disclosed. The invention being comprised of four parts. A first part being a conventional locking latch assembly, a second part being a serrated blade slidably configured inside a third part comprised of a two-piece, buckle case. A fourth part being an easy-to-reach handle allowing the user to pull and sever a belt thereon. An object of the invention is to allow a user to escape a seat belt quickly during an emergency.

### FIELD OF THE INVENTION

The present invention generally relates to seat belts. More specifically, it relates to a system of severing a seatbelt using a large handle device built into a seat belt latch.

### BACKGROUND

Seat belt restraints were first invented by an engineer named George Cayley to help keep pilots inside gliders. The first patented seat belt was created by Edward Claghorn 1885 in order to keep tourists safe in taxis in New York City. Over time, safety experts conducted research and demonstrated that such restraints prevented drivers and passengers from being ejected from vehicles thereby reducing injuries. Later in the 1950s, the Sports Car Club of America required race car drivers to wear lap belts during competitions and the Society of Automotive Engineers appointed a Motor Vehicle Seat Belt Committee to promote seat belt use for the general public. In 1966 the United States enacted the National Traffic and Motor Vehicle Safety Act of 1966 and required seat belts be installed in all vehicles sold within the country. In 1970, the world's first seat belt law was created in Australia, which required vehicle passengers to wear their seat belts at all times. Today, a majority of seat belts consist of a combination shoulder and lap belt releasably connected to a seat connector by means of a buckle on one side of a user and a retractor connected to the vehicle pillar on another side of a user. The release mechanism on these buckles usually consist of small, low-profile buttons and are discreet for comfort. Unfortunately, they can also be difficult to operate during an emergency because they can be difficult to find and need to be depressed at an angle facing a user. In some instances, users can become trapped in seat belts that malfunction in accidents or that fail to release when under extreme tension (such as when a driver is hanging in a belt upside down).

Engineers have started developing devices affixed to seat belts to release them quickly in such emergencies. U.S. Pat. No. 4,009,905A granted to Bejeannin disclosed a set of two cutting buckles for a seatbelt for the lap and chest belt. U.S. Pat. No. 5,085,449A, U.S. Pat. No. 6,148,520A, 20060169120A1, 20040140142A1 and U.S. Pat. No. 6,453,564B1 granted to Hudson, Berns, Smith, MacDougall and Foley respectively, disclosed external retrofit cutters for seat belts that are not affixed to the belt. U.S. Patent No. 20160221533A1 granted to Flegar and Dardinier disclosed a seat belt cutter that relies on heat to melt said belt. U.S. Pat. No. 5,395,136A granted to Buchner disclosed a seat buckle remover having two blades and not a single blade. U.S. Pat. No. 8,608,247B2 granted to Roman and Schwartz disclosed a shoulder strapping system for comfort but does not sever a belt. U.S. Pat. No. 5,653,031A granted to Richter disclosed a seat belt cutting device inside a protective cover located on a belt that requires a user to first open the case to gain access to cutter. While many of these patents incorporate various forms of cutting blades in their inventions, none were found that included a large pull handle at a single location for easy access that is contained within a component of the buckle itself as well as a serrated cutter.

### SUMMARY OF THE INVENTION

The device herein disclosed and described provides a solution to the shortcomings in the prior art through the disclosure of a seat belt buckle that severs a said belt in an emergency. An object of the invention is to allow a user to escape from a defective seat belt in an emergency. Should a problem occur with the conventional buckle portion of the invention, the user can easily access the pull handle and sever the belt.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the invention installed on a belt.

FIG. 2 shows a front view of the invention severing a belt.

FIG. 3 shows a perspective exploded view of the invention.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

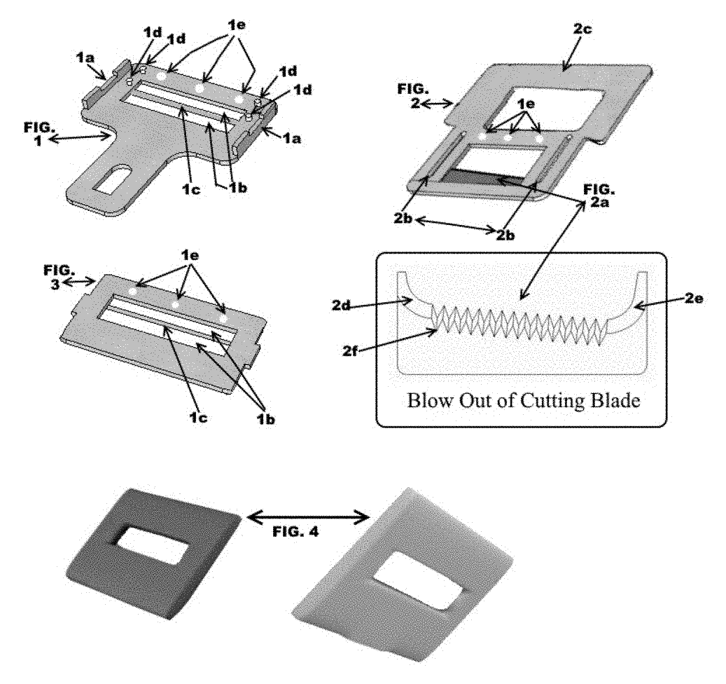

FIG. 1 shows a perspective view embodiment of the invention installed on belt and having three main parts: buckle housing 2 (made of a rigid material such as, but not limited to plastic, metal and the like), latch 4 (comprised of, but not limited to metal etc.) and handle 1 (also being comprised of, but not limited to metal and the like). Said invention having two proximal, rectangular slots configured to receive belt 3 therein.

FIG. 2 shows a front view embodiment of the invention severing a belt 3. As handle 1 is raised, it pulls cutting blade 7 into contact with said belt 3 allowing it to be cleanly severed.

FIG. 3 shows a perspective exploded view embodiment of the invention having several components that are sandwiched together therebetween. The figure showing latch 4 being planar and having a rectangular shape with a distal end having a protrusion with latch tongue 18 including a square shape and aperture 19 configured to be received by a conventional belt buckle receiver therein. Said latch 4 having at least two belt loop openings 17 disposed along the longitudinal axis (to receive belt 3); four raised, cylindrical-shaped guide pins 16, at least three cover holes 11 on another distal end and four raised sidewall supports 15 on distal perimeter edges thereatop.

FIG. 3 shows handle 1 having a square shape also being made of, but not limited to metal and the like and having pull handle 8 coated with a rigid yet flexible material such as but not limited to, rubber and the like. A proximal portion having a square aperture configured to receive belt 3 and a distal end having a serrated cutting blade 7 fixedly connected there in. The blade having curved radia at each distal end of at least six millimeters and chamfered cutting edges with at least a five degree rake thereon. The figure also showing at least three cover holes 11 on another distal end and two rectangular-shaped track apertures 14 perpendicular to the longitudinal axis to receive the aforementioned guide pins 16 as well as at least three coverholes 11.

FIG. 3 further showing securement plate 6 having a rectangular shape and made of a rigid material such as metal and the like with two portions extended on each distal end to be received by said sidewall supports 15 on latch 4. Plate 6 being affixed to said latch 4 allowing handle 8 to be slidably affixed therebetween. The figure also showing plate 6 having at least two rectangular apertures 12 to receive belt 3 as well as at least three cover apertures 11 thereon.

FIG. 3 finally showing cover plates 10 being made of, but not limited to a lightweight, rigid material such as but not limited to plastic and having a rectangular shaped aperture 10 to receive belt 3 and having a chamfered perimeter 8. Said covers having, but not limited to three molded pins, screws etc. on each inwardly facing surface to be received by cover holes in said components 6, 1 and 4 sandwiched therebetween.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. The Seat-belt Buckle with Built-in Belt Cutter in a emergency can save the life of a person(s) when the release mechanism jams and/or malfunctions due to an accident. The handle of the serrated blade easily cuts through the seat belt in one pull. It is most especially lifesaving when the vehicle has rolled over, and/or has been submerged in water and the person(s) can't remove their seat-belt, thus remaining trapped.

1. The seat belt looped through the two openings in the middle of the buckle, rests flat at the center of the buckle. The handle of the serrated blade easily cuts through the seat belt in one pull, allowing the person(s) mobility from their seat(s).

2. The unique construction of the Seat-belt Buckle with Built-in Belt Cutter is like no other in the market, Consisting of three pieces sandwiched together, the base, the blade handle in the center, and the top cover, completes the fundamental components of this invention. Additional plastic covers are added for aesthetic purposes.

3. The buckle is designed to fit and/or accommodate to any car manufacturer brand by itself or adding the plastic covers from the car manufacturer brand.
